(19) United States
(12) Patent Application Publication
(10) Pub. No.: US 2017/0186041 A1
(43) Pub. Date: Jun. 29, 2017

(54) RETARGETING SYSTEM FOR DECISION MAKING UNITS

(71) Applicant: International Business Machines Corporation, Armonk, NY (US)

(72) Inventors: Ying Li, Mohegan Lake, NY (US); Rong Liu, Sterling, VA (US); Pietro Mazzoleni, New York City, NY (US); Pavankumar Murali, Elmsford, NY (US); Sachin Pai, Princeton, NJ (US); Anshul Sheopuri, Teaneck, NJ (US); Roman Vaculin, Bronxville, NY (US)

(21) Appl. No.: 14/979,984

(22) Filed: Dec. 28, 2015

(51) Int. Cl. G06Q 30/02

(52) U.S. Cl. CPC G06Q 30/0269; G06Q 30/0246; G06Q 30/0273

(57) ABSTRACT

An aspect of the disclosure includes a method, a system and a computer program product for retargeting content to a decision making unit. The method including determining a journey stage for each of the plurality of individuals. A retargeting strategy is identified for each of the plurality of individuals, the retargeting strategy based at least in part on the journey stage for each of the plurality of individuals and a cost factor. Content data is transmitted to at least one of the plurality of individuals using retargeting based at least in part on the retargeting strategy.

### BACKGROUND

The present invention relates generally to a system and method for delivering content to a group of individuals involved in a purchase of a product or service, and in particular to a system and method of retargeting the delivery of information based on a current journey stage of a purchasing process of an individual relative to the group of individuals.

Decisions to purchase products and services are frequently based on a consensus between groups of people. In a business setting, this group could include a purchasing agent, an engineering manager and a finance manager for example. Each of the members of the group needs to approve the purchase before the purchase can proceed forward and finalized. It should be appreciated that the purchasing process may proceed through a number of stages before the purchase is approved and finalized. Since each of the individuals may be at a different stage in the process, the decision to purchase may be delayed or the process protracted.

### SUMMARY

Embodiments include a method, system, and computer program product for retargeting content to a decision making unit. The method including determining a journey stage for each of the plurality of individuals. A retargeting strategy is identified for each of the plurality of individuals, the retargeting strategy based at least in part on the journey stage for each of the plurality of individuals and a cost factor. Content data is transmitted to at least one of the plurality of individuals using retargeting based at least in part on the retargeting strategy.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment;

FIG. 2 depicts abstraction model layers according to an embodiment;

FIG. 3 depicts a flow diagram for advancing a decision making unit to a purchasing decision;

FIG. 4 depicts a block diagram of a system for delivering content to a decision making unit for influencing a purchasing decision;

FIG. 5 depicts a flow diagram of a portion of the system of FIG. 4 for determining a journey stage for an individual in the decision making unit in accordance with some embodiments;

FIG. 6 depicts a flow diagram of a portion of the system of FIG. 4 for determining a journey stage for an individual in the decision making unit in accordance with another embodiment;

FIG. 7 depicts a flow diagram of a portion of the system of FIG. 4 for determining a retargeting strategy in accordance with some embodiments;

FIG. 8 depicts a flow diagram for a portion of the system of FIG. 4 for advancing an individual in a decision making unit to a next journey stage of a purchasing process in accordance with some embodiments;

FIG. 9A depicts a flow diagram for a portion of the system of FIG. 4 for determining content for a business case strategy in accordance with some embodiments;

FIG. 9B and FIG. 9C depict an example of a business case strategy of FIG. 9A;

FIG. 10 depicts a flow diagram for a portion of the system of FIG. 4 for refining a retargeting strategy in accordance with some embodiments; and

FIG. 11 depicts table illustrating an embodiment of the retargeting strategy method of FIG. 10.

### DETAILED DESCRIPTION

Embodiments of the present disclosure provide for a system and method for delivering content to a group of individuals in a decision making unit involved in a purchase of a product or service. Embodiments provide for advancing individuals through the journey stages or stages of the purchasing process and retargeting content to the individuals who may influence others in the decision making unit to advance the decision making unit as a whole through the purchasing process.

It should be appreciated that while embodiments herein may refer to the decision making unit as having a group of members, this includes a group of two individuals. Further, it should be appreciated that a decision making unit may be comprised of individuals who are in the direct approval process for the purchase (e.g. purchasing managers and finance managers) as well as those individuals who influence the members with approval authority (e.g. engineers and information technology team members). Further, it should be appreciated that while embodiments herein refer to a system and method for the purchase of a product or service in a business context, the system and methods disclosed herein may also be used in connection with consumer purchases.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts).
Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

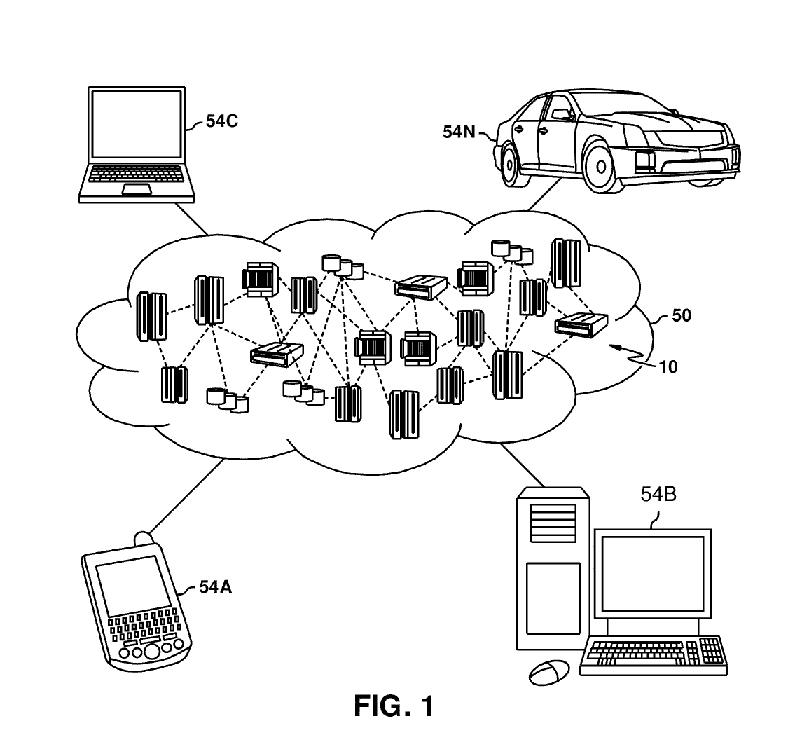

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

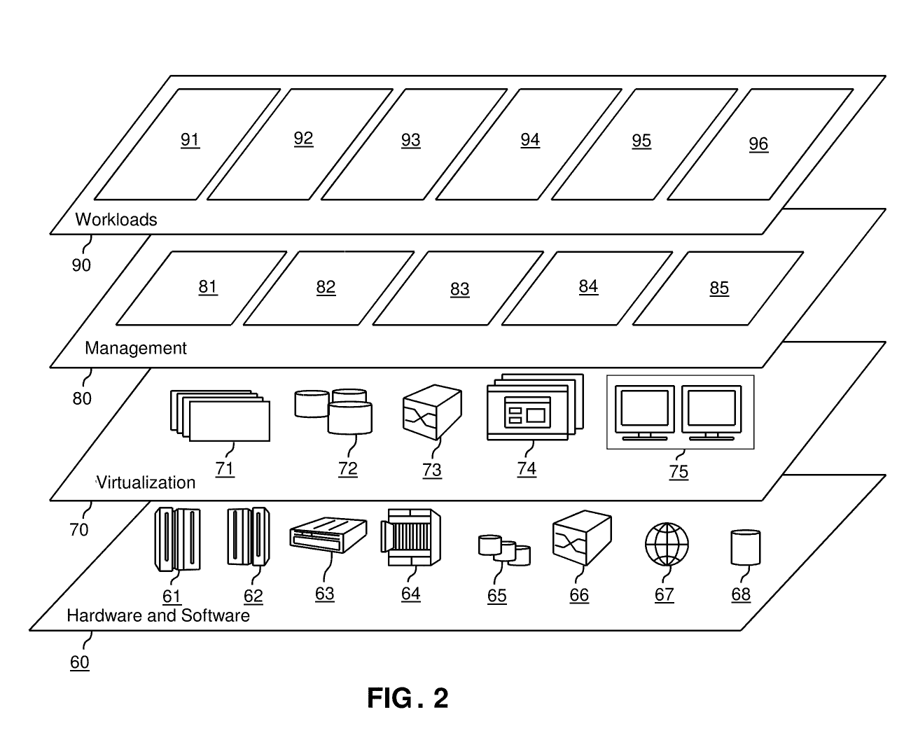

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

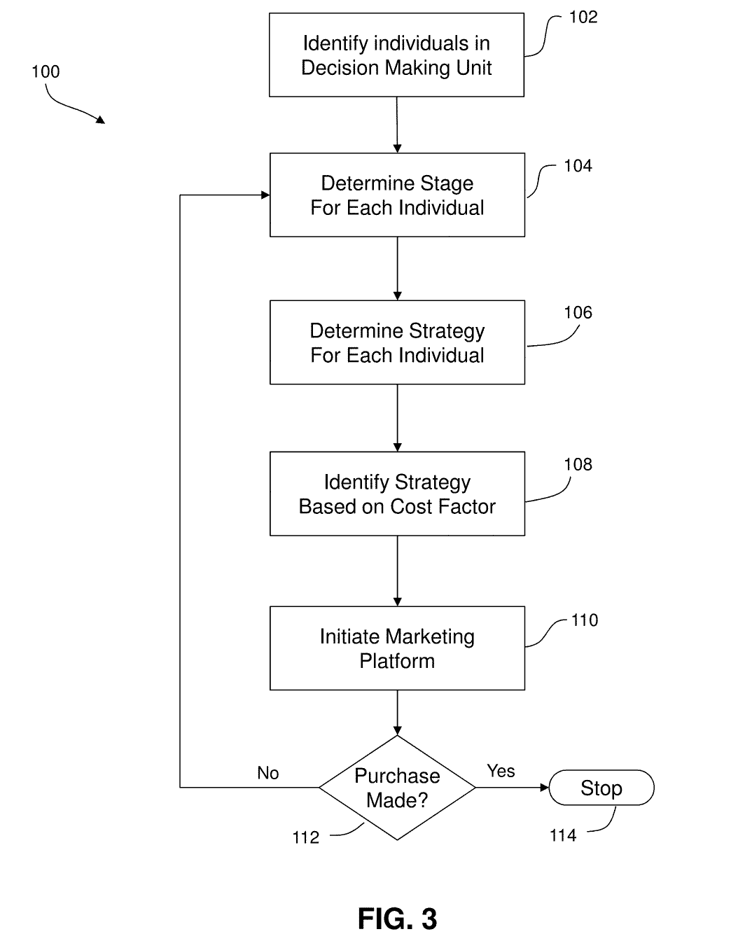

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a retargeting and content delivery processing 96. The retargeting and content delivery processing 96 may perform one or more methods that allow the delivery of content to one or more members of a decision making unit, such as but not limited to the methods described in reference to FIGS. 3-10 for example.

As used herein, the term “content” or “content data” is information related or associated with the product or service being sold. Content may include advertisements, white papers, financial analysis, educational materials, surveys and the like.

Referring now to FIG. 3, an embodiment is shown of a method 100 for delivering content to individuals within a decision making unit. The method 100 begins in block 102 where the individuals of the decision making unit are identified. The method then proceeds to block 104 where the journey stage of the purchasing process is identified for each individual in the decision making unit. It should be appreciated that each individual may personally be at a different journey stage of the process, with one individual being ready to finalize the purchase and another still be comparing different vendors. In an embodiment, the journey stages of the purchasing process may include, but are not limited to: a discover stage, a compare stage, a consider stage, a commit stage and a retain/purchase stage. As will be discussed in more detail herein the content delivered to a particular individual within the decision making unit will depend on the journey stage that the individual is at, and the journey stage of the other individuals in the decision making unit.

Once the journey stages are determined, a content retargeting strategy for each individual is determined in block 106. The content retargeting strategy may include advertisements, information on how to educate others within their company about the product or service and a change in frequency of content delivery for example. The method then proceeds to block 108 where the retargeting strategy is selected among the content retargeting strategy's in block 106 based on different criteria, such as, as example, a cost factor. The cost factor may include a cost to deliver the content and a probability that the individual may influence others in the decision making unit. With the refined retargeting strategy determined the method 100 proceeds to block 110 where a marketing platform transmits the content to one or more individuals in the decision making unit.

The method 100 then proceeds to query block 112 where it is determined if the decision making unit has completed the journey as defined by a marketer. As example, a complete process might be the purchasing of a product. When query block 112 returns a negative, the method 100 loops back to block 104 where the journey stage of each individual is once again determined. When query block 112 returns a positive, meaning that a purchasing journey of the decision making unit is completed, the method 100 proceeds to block 114 and terminates. It should be appreciated that in other embodiments, the method 100 may include additional decision points which may result in the termination of the process. For example, the method 100 may include a query block which determines if the individuals have stopped progressing through the journey stages of the purchasing process. If progress has been stagnant for a predetermined period of time (indicating a low probability of completing the sale), the method 100 may terminate. In another embodiment, the method 100 may include a query block that compares the cost factors with a predetermined value and when the cost to deliver the content to progress the decision making unit exceeds a threshold, the method 100 may be suspended or terminated.

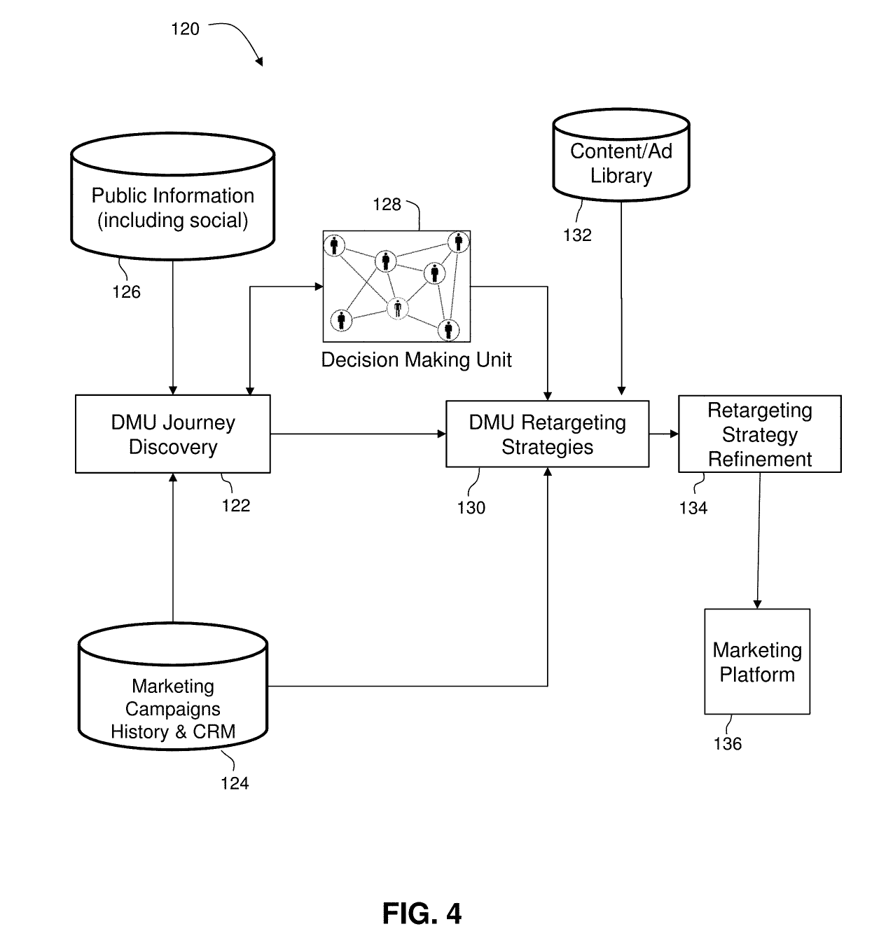

Referring now to FIG. 4, a system 120 is shown for determining a retargeting strategy and delivering content to a decision making unit, such as using the method of FIG. 3 for example. The system 120 includes a decision making unity journey discovery module 122. The discover module 122 aggregates information from databases, such as public databases 126 and private databases 124. Public databases 126 include information, such as firmographic data, company size, industry, and historical sales data for example, from publically available sources such as annual reports, governmental filings along with news and press release information for example. Private databases 124 may include information not generally available to the public, such as historical data on marketing campaigns, customer relations management (CRM) systems and the like. Private databases 124 may include information that is collected internal to the seller's business and also data purchased from outside suppliers. The discovery module 122 further aggregates data on the decision making unit 128 to identify the individuals involved in the purchasing process or may otherwise influence the outcome of the purchasing decision.

The discovery module 122 aggregates the data and determines the current journey stage of the purchasing process for each of the members of the decision making unit. The discovery module 122 then transfers these journey stages to a retargeting strategy module 130. In an embodiment, the term “retargeting” might refers to a use of content delivery methods that utilize a tracking application, sometimes colloquially referred to as a “cookie,” for determining where on a computer network, such as the Internet, a particular user has or is visiting. These cookie-based content delivery methods allow for the delivery of content, such as advertisements for example, to a user that are personalized to that particular user. It should be appreciated that while the use of cookie-based delivery methods are described herein, this is for exemplary purposes and the claimed invention should not be so limited. In other embodiments other tracking methodologies may be used. For example, where a user is using a mobile application, the mobile application may directly track and store the desired information. The retargeting strategy module 130 combines the journey stage and the tracking application with a content library 132 to determine which content from the content library 132 will be delivered, the method of delivery and the frequency of delivery. The determination of which content to deliver may be based on one or multiple strategies described herein.

For example, in an embodiment a decision making unit is comprised of a project manager, a chief technology officer (CTO) and a chief financial officer (CFO). The discover module determines the project manager has decided that a product is the right product to purchase (commit stage), that the CTO does not believe the product is a good fit (failure at the consider stage), and the CFO has not yet been exposed to the product (discover stage). In this embodiment, the retargeting strategy module 130 may reduce the frequency of advertisements to the project manager while increasing the delivery of content that assists him in making his business case and to gather information about the concerns of others. The content may include educational information on the product that helps the project manager persuade others (e.g. the CFO). The retargeting strategy module 130 may change the content delivered to the CTO based on the information gathered from John about concerns of others. The retargeting strategy module may further retarget the CFO with focused content to educate her about the product and also with information to overcome the CTO's concerns.

In an embodiment, the retargeting strategy module 130 may determine multiple strategies for delivering content to the individuals in the decision making unit. As discussed in more detail herein, multiple regarding strategies may be determined by the module 130. In an embodiment, the multiple strategies are narrowed using an optimization process based on a user defined criteria, such as a cost function for example. The system 120 may further include a retargeting refinement module 134. The retargeting refinement module 134 applies predetermined criteria and predetermined goals. Predetermined criteria may include criteria such as cost factors to determine a retargeting strategy to proceed forward with. Predetermined goal may include seller objectives such as converting individuals to the next journey stage or closing the sale for example. In an embodiment, the retargeting refinement module balances the criteria and the goals to increase or maximize the conversion rates to advance individuals through the purchasing process while also reducing or minimizing content delivery financial or computational costs. For example, the retargeting refinement module 130 may increase the frequency of content delivery to the CFO even though it is most costly due to a probability of the CFO persuading the CTO to purchase the product.

The selected retargeting strategy is then input into a marketing platform 136 that delivers the content to the individuals of the decision making unit. As discussed above, the content, such as advertisements for example, may be delivered to the individuals of the decision making unit as they utilize computer networks 50 (e.g. the Internet) such a tracking application or cookie.

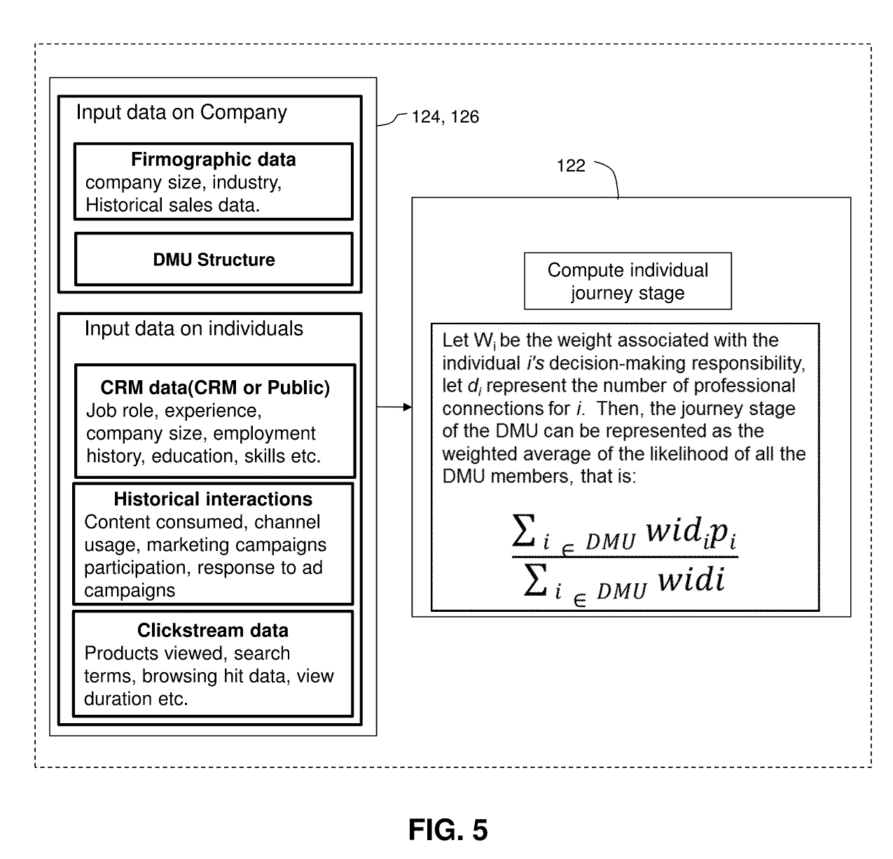

Referring now to FIG. 5, one embodiment is shown of the discovery module 122. In this embodiment, the discovery module 122 receives data from the databases 124, 126. The data may include data on the company, such as firm data (e.g. company size, industry, sales date) and data regarding the structure or organizational chart (e.g. roles and responsibilities) of members of the decision making unit. The data may further include information on individuals of the decision making unit, such as CRM data (e.g. job role, experience, employment history, education, skills), historical interaction data (e.g. content consumed, channel usage, marketing campaign participation, response to advertisement campaigns), and clickstream data (e.g. products viewed, search terms, browsing hit data, view duration). In one embodiment, the input data on individuals may include social media data.

The discovery module 122 receives the input data and in this embodiment determines a current journey stage using a weighted ratio defined by:

$$\frac{{\sum }_{i ∈ DMU} {w}_{i} {d}_{i} {p}_{i}}{{\sum }_{i ∈ DMU} {w}_{i} {d}_{i}} \qquad ( 1 )$$

Where wᵢ is the weight associated with the individual “i′s” decision-making responsibility. The term dᵢ is the number of professional connections for i. The journey position of the decision making unit may then be represented as the weighted average of the probability of all decision making unit members. In the formula, pᵢ represent the probability of an individual “i” to be on a given journey position.

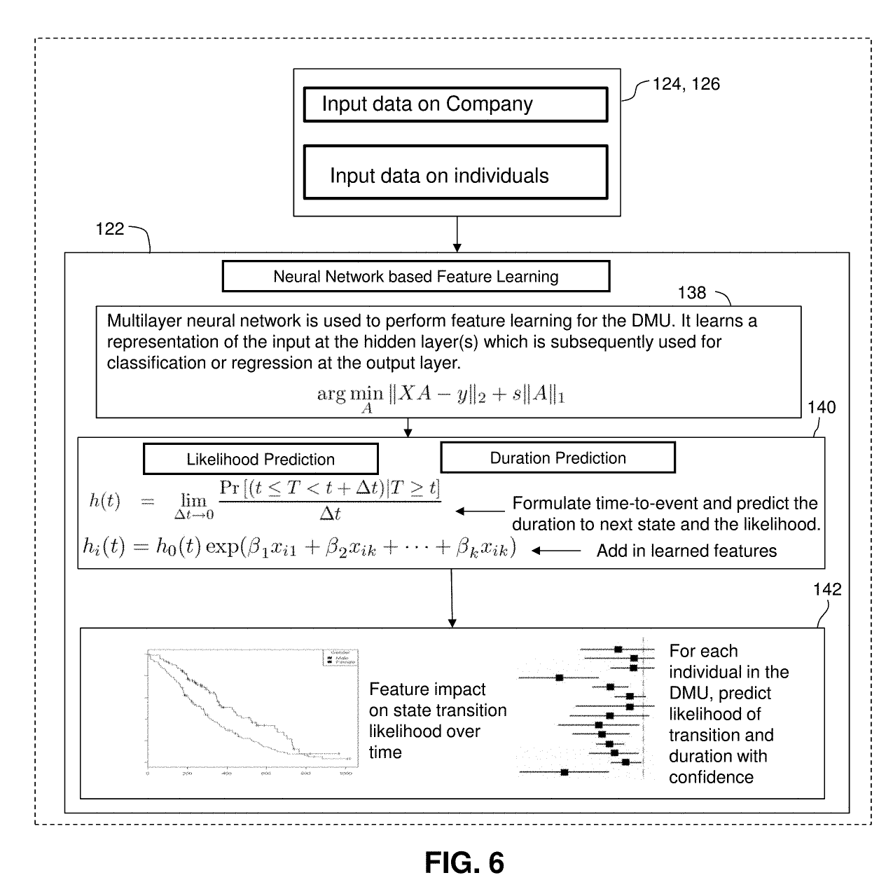

Referring now to FIG. 6 another embodiment is shown of the discovery module 122. In this embodiment, the discovery module 122 receives data from the databases 124, 126. The data received from the databases 124, 126 is the same as that discussed above with respect to FIG. 5 and will not be discussed further here for brevity. In this embodiment, the discovery module 122 uses a neural network based feature learning method to determine the journey stage of each individual in the decision making unit. The multilayer neural network learns a representation of the input at the hidden layer(s) which is subsequently used for classification or regression at the output layer in block 138:

$$arg {min}_{A} {‖ XA - y ‖}_{2} + s {‖ A ‖}_{1} \qquad ( 2 )$$

From this a likelihood prediction and a duration prediction may be formulated in block 140:

$$h ( t ) = {lim}_{Δ t \to 0} \frac{Pr [ ( t \leq T < t + Δ t ) \vert T \geq t ]}{Δ t} \qquad ( 3 )$$

The learned features may be added:

hᵢ(t)=h₀(t) exp(β₁xᵢ₁+β₂xᵢₖ+ . . . +βₖxᵢₖ) (4)

As a result, in block 142 the feature impact on state transition likelihood over time may be determined for each individual in the decision making unit. Further, a prediction of the likelihood of transition and duration along with a confidence band may be determined.

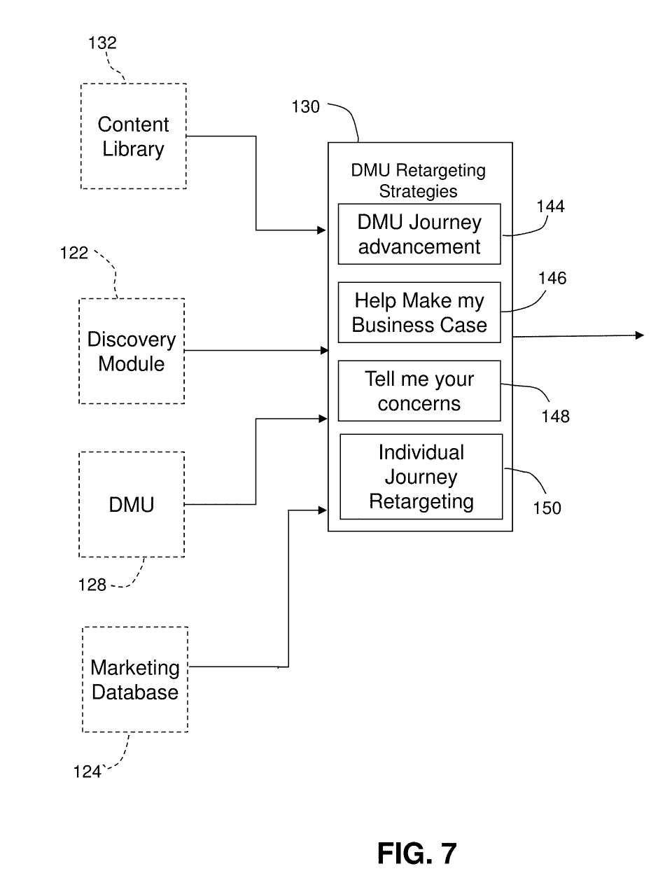

Referring now to FIG. 7, an embodiment is shown of the retargeting strategy module 130. In this embodiment, retargeting strategy module 130 receives inputs from one or more of the following: the discovery module 122, the marketing database 124, the decision making unit database 128 and the content library 132. Based on these inputs, the retargeting strategy module 130 selects from one of retargeting strategies: journey advancement 144, business case 146, collect concerns 148 and individual journey retargeting 150.

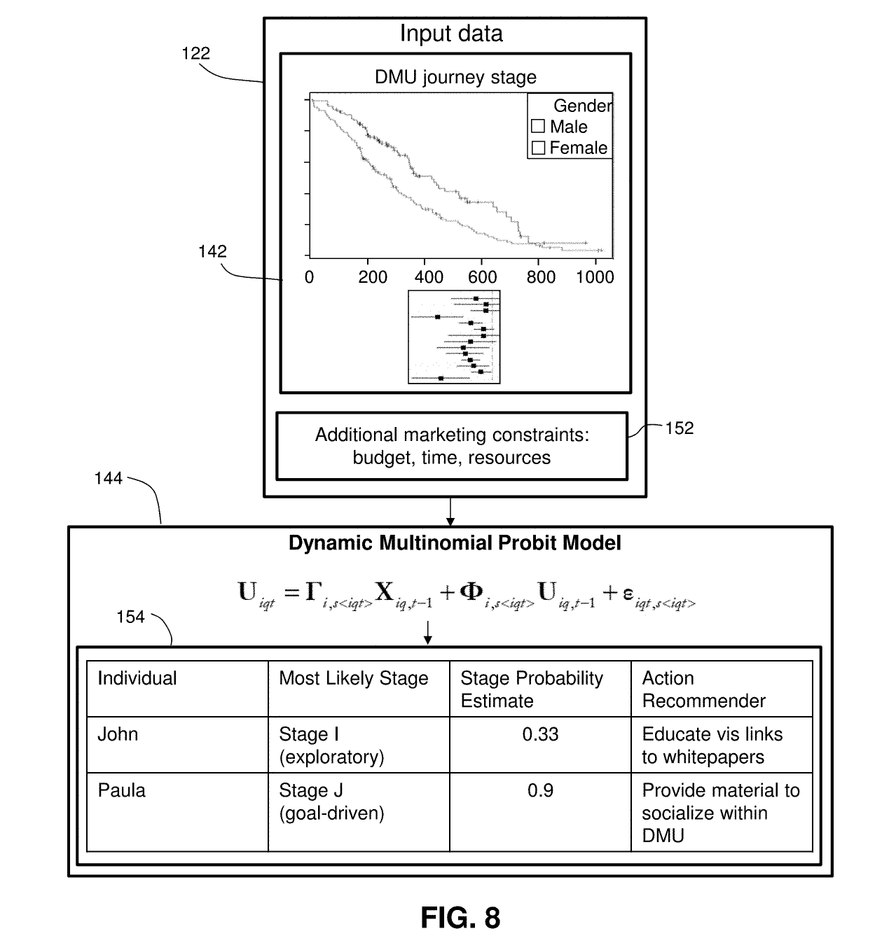

Referring now to FIG. 8 with continuing reference to FIG. 7, the journey advancement strategy 144 will be described. The journey advancement strategy 144 provides a retargeting strategy to determine how to quickly advance an individual through the purchasing process journey considering the journey stage of all other individuals in the same decision making unit. The journey advancement strategy 144 receives the input from the discovery module 122, such as the results from block 142 of the neural network for example. The input may further include additional data 152 such as marketing constraints, budget, time allotment and resources.

In this embodiment, the journey advancement strategy 144 determines a desired increase in the probability of transition for the decision making unit and a prediction on the increase in probability of transition for an individual in the decision making unit based on a marketing plan of action. In an embodiment, the probabilities are determined using a dynamic multinomial probability model:

U_{iqt}=Γ_{i,s<iqt>}X_{iq,t-1}+Φ_{i,s<iqt >}U_{iq,t-1}+ε_{iqt,s<iqt>} (5)

Where Uₜ is the predicted desired marking action for a user at time instant t; Γ is a transition probability in the network of journey states; Xₜ₋₁ is a journey state of a user at time t−1; Φ_{i,s} is a transition probability in the network of action states; Uₜ₋₁ is an action taken for a user at time t−1; and ε is an error term.

This models the individual activities depending on latent states. This also models the switching between states and the incorporation of external covariates. The result of this analysis may be presented as a table 154. In this example, two individuals are analyzed. Individual 1 is at stage I (exploratory) and the analysis provides a journey stage change probability of 0.33. As a result, the recommended action for the journey advancement strategy of Individual 1 is to transmit hyperlinks to white papers on the product (or problems solved by the product). Individual 2 is currently at stage J (goal-driven) and have a journey stage change probability of 0.9. The recommended action for journey advancement strategy for Individual 2 is to transmit content with information that would be beneficial to share (such as through social media) to others in the decision making unit.

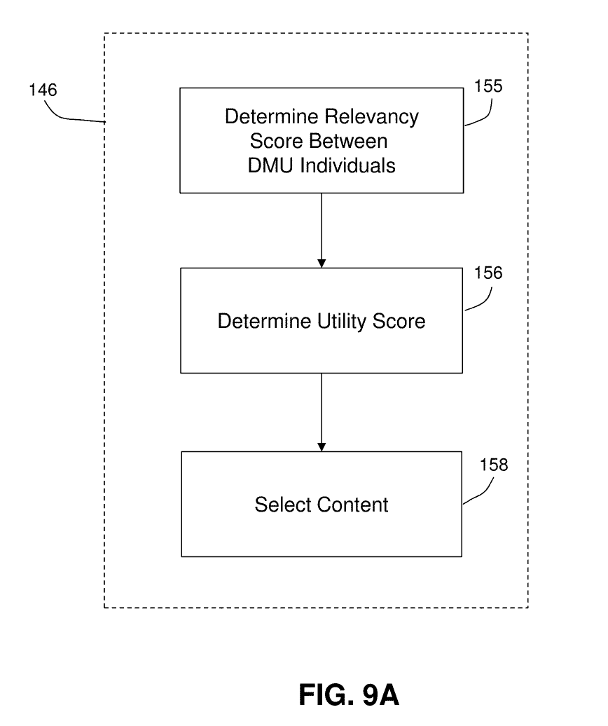

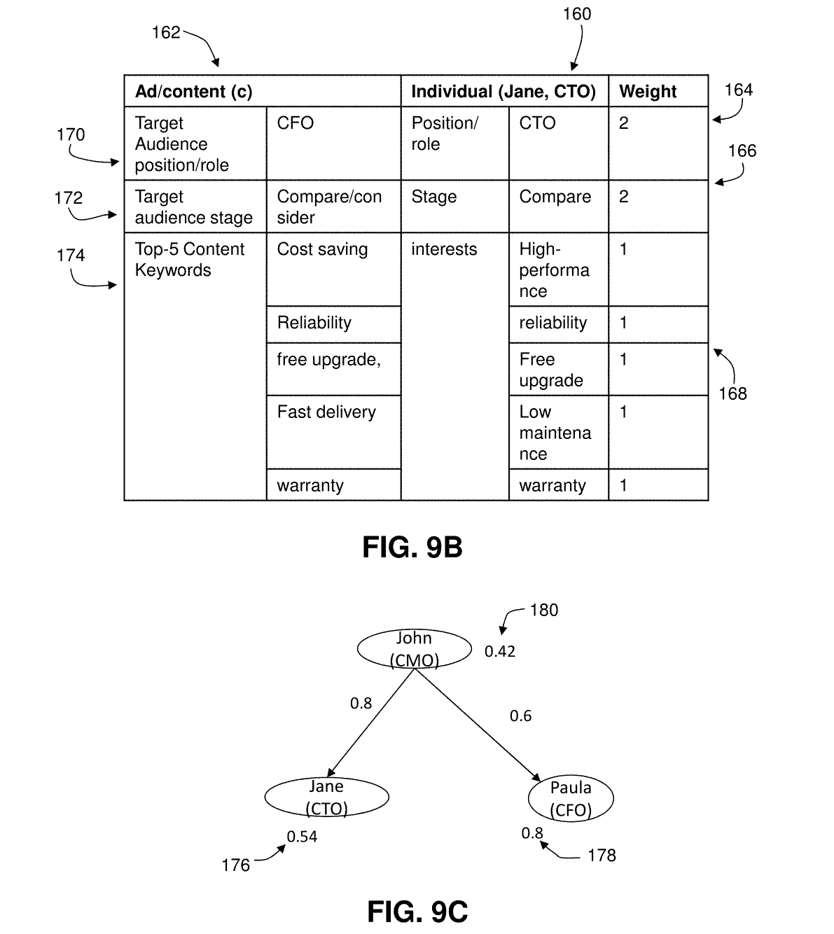

Referring now to FIG. 9A with continuing reference to FIG. 7, an embodiment is shown business case strategy 146. The business case strategy 146 provides for dynamically identifying the content (e.g. advertisements) that an individual in the decision making unit will need to help him/her making a business case for purchasing the product or service to a another member of the decision making unit. Typically this strategy is used for an individual already in an advanced or later journey stage of the purchasing process.

The business case strategy 146 begins with a set of assumptions. For example, let B={b_1, . . . b_m} be the journey stages of the purchasing process journey (e.g. discover, compare, consider, commit, retain etc.). For simplicity, assume the same journey for all individuals and a purchase is finalized when all individuals within a decision making unit are at stage b_m. Given that a decision making unit “U” is composed of a set of individuals {u_1, . . . n_n} with known positions or roles (e.g. CTO, CMO etc.) and current journey stage journey stage. A known influence-ability score Influ(k, i) is defined indicating the likelihood of individual “u_k” to move in the purchasing process journey when they receive content from individual “u_i.”

As shown at block 155, a relevancy score is determined between individual “u_k” and an advertisement/content “c.” In an embodiment, the relevancy score is based at least in part on the user profile 160 (FIG. 9B) and an advertisement/content profile 162. In an embodiment, the user profile includes position/role 164, stage 166, and interests 168 as a set of keywords extracted from browsing history. For new users, interests can be inferred from users in the same position/roles. In an embodiment, the advertisement/content profile includes target audience position/role 170 and stage 172, and keywords 174 from the text of the content. The relevancy score is then determined from the cosine similarity between user and advertisement/content profiles. In an embodiment, the determination may be weighted to emphasize some aspects of the user and advertisement/content profiles.

In the embodiment illustrated in FIG. 9B, the cosine similarity score 176 for the content “c” with respect to the CTO “Jane” is:

$$\frac{2 * 2 + 1 * 1 + 1 * 1 + 1 * 1}{\sqrt{4 + 4 + 1 + 1 + 1 + 1 + 1} * \sqrt{4 + 4 + 1 + 1 + 1 + 1 + 1}} = 0.54$$

Similarly, the cosine similarity score 178 for the CFO “Paula” (FIG. 9C) may be determined to be R_{CFO}=0.8 and the cosine similarity score 180 for project manager “John” may be determined, R_{J}=0.42.

Next the method for the business case strategy 146 proceeds to block 156 where a utility score is determined. The average utility score of decision making unit is achieved based on the advertisement/content “c” for an individual “u_i” is:

$${\sum }_{u\_k ∈ U} sim ( u\_k , c ) * influ ( u\_k , u\_i ) / n \qquad ( 6 )$$

Using the example of FIG. 9B and 9C, the utility score for delivering the content “c” to the project manager “John” is shown. The utility score for delivering the average utility score is:

$$\frac{{R}_{J} + ( {U}_{J - CTO} * {R}_{CTO} ) + ( {U}_{J - CFO} * {R}_{CTO} )}{3} \qquad ( 7 )$$

Thus the average utility for the content “c” is 0.444. This process may be repeated for each of the advertisements and content data within the content library 132. The method for the business case strategy 146 then proceeds to block 158 where one or more advertisements/content to be shown to u_i are selected based on an average utility scores. In one embodiment, content having an average utility score based on a predetermined threshold are selected.

The collect concerns strategy 148 is similar to that of the business case strategy 146, except that the content is transmitted to the individuals within the decision making unit with the purpose of soliciting feedback. This feedback may be in the form of a targeted survey for example. In one embodiment, the survey is coupled to a cognitive computing module (not shown) that is configured to analyze unstructured data (such as freeform responses from the individual by using natural language processing to understand grammar and context). The cognitive computing module is used to interpret the question and intelligently select the most relevant content to be showed to the user. The content may not only be configured to retrieve based on its relevance to the question, but also based on the ability of the individual positing the question to influence others in advancing their journey toward purchase. In an embodiment, a scoring mechanism is derived from historical data to indicate the likelihood of an individual to pose the question.

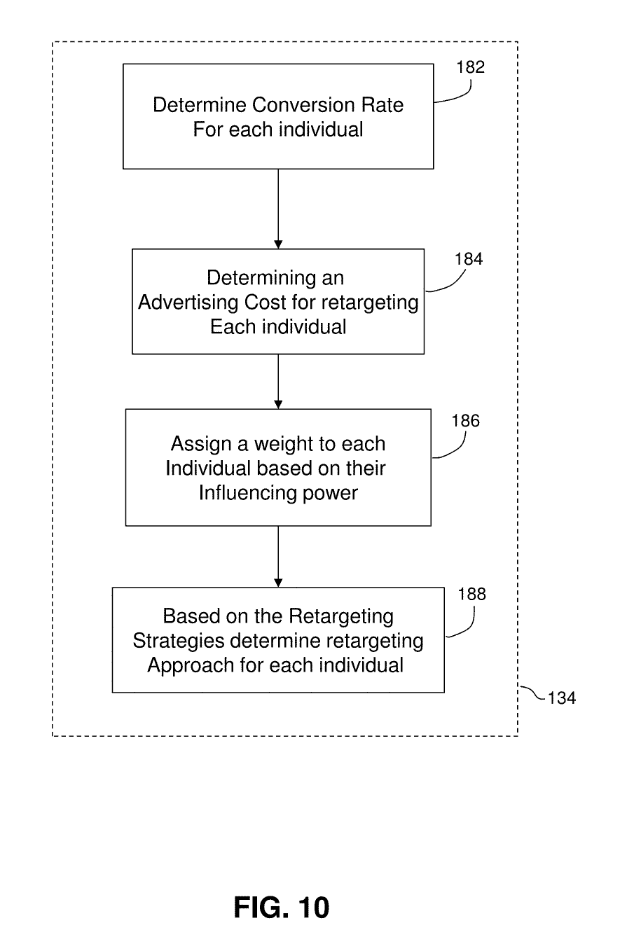

Referring now to FIG. 10, an embodiment is shown of the retargeting refinement module 134. The retargeting refinement module 134 receives the recommended strategies from the retargeting strategy module 130 and focuses or refines the implemented strategy based on predetermined criteria and predetermined goals. In the exemplary embodiment, the predetermined criteria is the conversion rate and advertiser cost. The conversion rate is the expected advancement of the individual from their current journey stage to the next journey stage of the purchasing process. The advertising cost is the financial cost for retargeting each individual in a specific manner based on the strategy. The predetermined goal may be to increase or maximize conversion while reducing, minimizing or fixing the total advertising cost.

The method of retargeting refinement module 134 starts in block 182 with determining of the conversion rate for each individual. The method then proceeds to block 184 and an advertising cost for retargeting each individual is determined. In one embodiment, the individuals may be weighted based in block 186 on their influence power in making the decision. For example, the chief technology officer may have a higher weight than the project manager.

The method then proceeds to block 188 where a retargeting approach for each individual is determined. In one embodiment, the retargeting approach may be a combinatorial optimization, sometimes referred to as a knapsack or rucksack problem. In this approach, given a set of items, each with a weight and a value, the number of each item is determined to be included in a collection so that the total weight is less than or equal to a given limit and the total value is as large as possible. In the exemplary embodiment, the recommended strategies are evaluated to have the highest conversion rate for the lowest advertising cost.

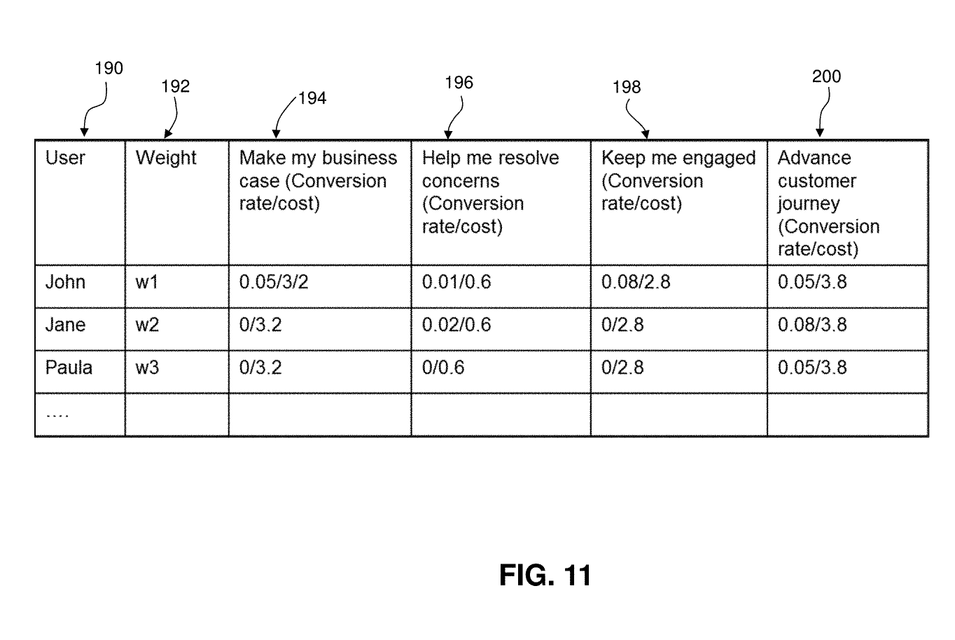

Referring now to FIG. 11 with continued reference to FIG. 10, an example is of a retargeting refinement strategy. In this embodiment, the users 190 are each assigned a weight 192. Then for each of the strategies 194, 196, 198, 200 a conversion rate and cost are determined. Based on the conversion rate and cost data, combinatorial optimization may be performed to determine which strategy, or combination of strategies, should be transmitted to the marketing platform.

Technical effects and benefits of some embodiments include providing a system for aggregating data from multiple sources and determining a method of retargeting one or more individuals in a decision making unit based on a current journey stage in the process that the particular individual is and the journey stages of the other individuals in the decision making unit.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
determining a journey stage for each of the plurality of individuals;
identifying a retargeting strategy for each of the plurality of individuals, the retargeting strategy based at least in part on the journey stage for each of the plurality of individuals and a cost factor; and
transmitting content data to at least one of the plurality of individuals using retargeting based at least in part on the retargeting strategy.

2. The method of claim 1, wherein the determining a journey stage includes receiving a first input data on a company the plurality of individuals are employed and a second input data on each of the plurality of individuals.

3. The method of claim 2, wherein the determining a journey stage includes determining a journey stage based at least in part on a weighted average of the individuals decision-making responsibility, their number of professional connections and a probability of the individual influencing other individuals in a purchasing decision.

4. The method of claim 2, wherein the determining a journey stage includes determining the journey stage with a neural network.

5. The method of claim 1, wherein the identifying the retargeting strategies comprises one of: a journey advancement strategy, a business case strategy, an alleviate concerns strategy and an individual journey retargeting strategy.

6. The method of claim 5, wherein the journey advancement strategy includes determining a dynamic multinomial probability model based at least in part on marketing constraints, budget, and a probability of transition and duration.

7. The method of claim 5, wherein the business case strategy further comprises:
determining a relevancy score between the plurality of individuals;
determining a utility score for each individual based at least in part on the relevancy score; and
selecting the content data based at least in part on the utility score.

8. The method of claim 7, wherein the selecting the content data for at least one of the plurality of individuals is further based in part on a probability of the at least one of the plurality of individuals influencing other individuals in the plurality of individuals to advance to a next journey stage.

9. The method of claim 1, further comprising:
determining a conversion rate for each of the plurality of individuals based at least in part on a current journey stage for the individual;
determining an advertising cost for each of the plurality of individuals; and
assigning a weight parameter to each of the plurality of individuals based on an influencing parameter for the individual.

10. The method of claim 8, wherein the retargeting strategy is determined using a combinatorial optimization.

11. A system comprising:
a memory having computer readable instructions; and
one or more processors for executing the computer readable instructions, the computer readable instructions comprising:
determining a journey stage for each of the plurality of individuals;
identifying a retargeting strategy for each of the plurality of individuals, the retargeting strategy based at least in part on the journey stage for each of the plurality of individuals and a cost factor; and
transmitting content data to at least one of the plurality of individuals using retargeting based at least in part on the retargeting strategy.

12. The system of claim 11, wherein the determining a journey stage includes receiving a first input data on a company the plurality of individuals are employed and a second input data on each of the plurality of individuals and is based at least in part on a weighted average of the individuals decision-making responsibility, their number of professional connections and a probability of the individual influencing other individuals in a purchasing decision.

13. The system of claim 11, wherein the determining a journey stage includes receiving a first input data on a company the plurality of individuals are employed and a second input data on each of the plurality of individuals and includes determining the journey stage with a neural network.

14. The system of claim 11, wherein the identifying a retarget strategy includes identifying a retarget strategy selected from a group comprising: a journey advancement strategy, a business case strategy, an alleviate concerns strategy and an individual journey retargeting strategy.

15. The system of claim 14, wherein the journey advancement strategy includes determining a dynamic multinomial probabilty model based at least in part on marketing constraints, budget, and a probability of transition and duration.

16. The system of claim 14, wherein the business case strategy further comprises:
determining a relevancy score between the plurality of individuals;
determining a utility score for each individual based at least in part on the relevancy score; and
selecting the content data based at least in part on the utility score.

17. The system of claim 16, wherein the selecting the content data for at least one of the plurality of individuals is further based in part on a probability of the at least one of the plurality of individuals influencing other individuals in the plurality of individuals to advance to a next journey stage.

18. The system of claim 11, wherein the computer readable instructions further comprise:
determining a conversion rate for each of the plurality of individuals based at least in part on a current journey stage for the individual;
determining an advertising cost for each of the plurality of individuals; and
assigning a weight parameter to each of the plurality of individuals based on an influencing parameter for the individual.

19. A computer program product for retargeting content to a decision making unit, the computer program product comprising a computer readable storage medium having program instructions embodied therewith, the program instructions executable by a processor to cause the processor to perform:
determining a journey stage for each of the plurality of individuals;
identifying a retargeting strategy for each of the plurality of individuals, the retargeting strategy based at least in part on the journey stage for each of the plurality of individuals and a cost factor; and
transmitting content data to at least one of the plurality of individuals using retargeting based at least in part on the retargeting strategy.

20. The computer program product of claim 19, wherein the processor further performs:
determining a conversion rate for each of the plurality of individuals based at least in part on a current journey stage for the individual;
determining an advertising cost for each of the plurality of individuals; and
assigning a weight parameter to each of the plurality of individuals based on an influencing parameter for the individual.
